(19) United States
(12) Patent Application Publication
(10) Pub. No.: US 2026/0181677 A1
(43) Pub. Date: Jun. 25, 2026

(54) COMMUNICATION METHOD, TERMINAL DEVICE, AND NETWORK DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/539,125

(22) Filed: Feb. 13, 2026

Related U.S. Application Data
(63) Continuation of application No. PCT/CN2024/097805, filed on Jun. 6, 2024.

(51) Int. Cl. H04W 72/30; H04L 5/00; H04W 48/10

(52) U.S. Cl. CPC H04W 72/30; H04L 5/0094; H04W 48/10

(57) ABSTRACT

Provided are a communication method, a terminal device, and a network device. One example communication method includes: receiving, by a terminal device, a synchronization signal block/physical broadcast channel block (SSB) from a network device, wherein the SSB comprises a first bit field, and the first bit field indicates that the SSB is a non-cell-defined synchronization signal block/physical broadcast channel block (NCD SSB).

### CROSS-REFERENCE TO RELATED APPLICATIONS

This application is a continuation of International Application No. PCT/CN2024/097805, filed on Jun. 6, 2024, the disclosure of which is hereby incorporated by reference in its entirety.

### TECHNICAL FIELD

The present application relates to the field of communications technologies, and more specifically, to a communication method, a terminal device, and a network device.

### BACKGROUND

When different versions of terminal devices exist in a communications system, a synchronization signal block/physical broadcast channel block (synchronization signal block/physical broadcast channel block, SS/PBCH block, SSB) transmitted for a version of a terminal device may be received by another version of a terminal device and mistakenly used for cell access and measurement.

### SUMMARY

The present application provides a communication method, a terminal device, and a network device. Various aspects used in the present application are described below.

According to a first aspect, a communication method is provided, including: receiving, by a terminal device, an SSB transmitted by a network device, where the SSB is used to obtain system information of the network device, the SSB includes a first bit field, and the first bit field is used to indicate that the SSB is an NCD SSB.

According to a second aspect, a communication method is provided, including:
transmitting, by a network device, an SSB to a terminal device, where the SSB is used to obtain system information of the network device, the SSB includes a first bit field, and the first bit field is used to indicate that the SSB is an NCD SSB.

According to a third aspect, a communication method is provided, including: receiving, by a terminal device, an SSB transmitted by a network device, where the SSB is a first SSB or a second SSB; and the first SSB is transmitted on a synchronization raster, the second SSB is transmitted on a non-synchronization raster, and a format of the first SSB is different from a format of the second SSB.

According to a fourth aspect, a communication method is provided, including: transmitting, by a network device, an SSB to a terminal device, where the SSB is a first SSB or a second SSB; and the first SSB is transmitted on a synchronization raster, the second SSB is transmitted on a non-synchronization raster, and a format of the first SSB is different from a format of the second SSB.

According to a fifth aspect, a terminal device is provided, including: a receiving unit, receiving an SSB transmitted by a network device, where the SSB is used to obtain system information of the network device, the SSB includes a first bit field, and the first bit field is used to indicate that the SSB is an NCD SSB.

According to a sixth aspect, a network device is provided, including: a transmission unit, transmitting an SSB to a terminal device, where the SSB is used to obtain system information of the network device, the SSB includes a first bit field, and the first bit field is used to indicate that the SSB is an NCD SSB.

According to a seventh aspect, a terminal device is provided, including: a receiving unit, receiving an SSB transmitted by a network device, where the SSB is a first SSB or a second SSB; and the first SSB is transmitted on a synchronization raster, the second SSB is transmitted on a non-synchronization raster, and a format of the first SSB is different from a format of the second SSB.

According to an eighth aspect, a network device is provided, including: a transmission unit, transmitting an SSB to a terminal device, where the SSB is a first SSB or a second SSB; and the first SSB is transmitted on a synchronization raster, the second SSB is transmitted on a non-synchronization raster, and a format of the first SSB is different from a format of the second SSB.

According to a ninth aspect, a terminal device is provided, including a processor, a memory, and a transceiver. The memory is configured to store one or more computer programs. The processor is configured to invoke the computer program in the memory to cause the terminal device to perform some or all of the steps in the method according to the first aspect or the third aspect.

According to a tenth aspect, a network device is provided, including a processor, a memory, and a transceiver. The memory is configured to store one or more computer programs. The processor is configured to invoke the computer program in the memory to cause the network device to perform some or all of the steps in the method according to the second aspect or the fourth aspect.

According to an eleventh aspect, an embodiment of the present application provides a communications system, where the communications system includes the terminal device and/or the network device described above. In some implementations, the communications system further includes another device that interacts with the terminal device and/or the network device in the solutions provided in embodiments of the present application.

According to a twelfth aspect, an embodiment of the present application provides a computer-readable storage medium. The computer-readable storage medium stores a computer program, and the computer program causes a terminal device and/or a network device to perform some or all of the steps in the methods according to the foregoing aspects.

According to a thirteenth aspect, an embodiment of the present application provides a computer program product. The computer program product includes a non-transitory computer-readable storage medium that stores a computer program, and the computer program is operable to cause a terminal device and/or a network device to perform some or all of the steps in the methods according to the foregoing aspects. In some implementations, the computer program product may be a software installation package.

According to a fourteenth aspect, an embodiment of the present application provides a chip. The chip includes a memory and a processor, and the processor may invoke and run a computer program in the memory, to implement some or all of the steps of the methods according to the foregoing aspects.

In embodiments of the present application, regardless of whether the SSB transmitted by the network device includes the system information, the first bit field in the SSB indicates that the SSB is the NCD SSB. Therefore, for a terminal device that does not support an on-demand SSB, when receiving the on-demand SSB, the terminal device does not mistakenly perform access and measurement by using an SSB that does not belong to the terminal device, thereby reducing impact of the terminal device on communication.

### BRIEF DESCRIPTION OF THE DRAWINGS

FIG. 1 is a schematic diagram of a wireless communications system to which embodiments of the present application are applied.

FIG. 2 is a schematic flowchart of a communication method according to an embodiment of the present application.

FIG. 3 is a schematic diagram of an SSB beam scan and a transmission moment of an SSB burst set.

FIG. 4 is a schematic flowchart of a communication method according to another embodiment of the present application.

FIG. 5 is a schematic block diagram of a terminal device according to an embodiment of the present application.

FIG. 6 is a schematic block diagram of a network device according to an embodiment of the present application.

FIG. 7 is a schematic block diagram of a terminal device according to another embodiment of the present application.

FIG. 8 is a schematic block diagram of a network device according to another embodiment of the present application.

FIG. 9 is a schematic block diagram of an apparatus for communication according to an embodiment of the present application.

### DETAILED DESCRIPTION OF THE EMBODIMENTS

### Communications System

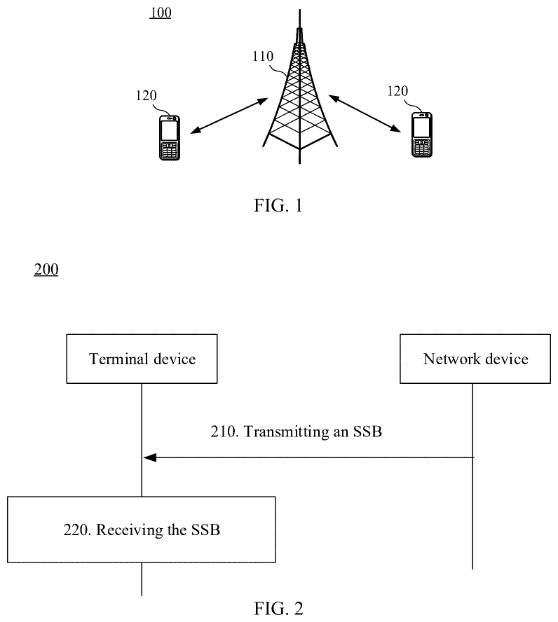

The technical solutions in the present application are described below with reference to the accompanying drawings. For ease of understanding, communication terms and communication processes that may be used in embodiments of the present application are first described with reference to FIG. 1.

FIG. 1 shows a wireless communications system 100 to which embodiments of the present application are applied. The wireless communications system 100 may include a network device 110 and a terminal device 120. The network device 110 may provide communication coverage for a specific geographic area, and may communicate with the terminal device 120 located within the coverage.

FIG. 1 exemplarily shows one network device 110 and two terminal devices 120. Optionally, the wireless communications system 100 may include a plurality of network devices 100, and another quantity of terminal devices 110 may be included in coverage of each network device 100. In addition, optionally, the wireless communications system 100 may further include other network entities such as a network controller and a mobility management entity.

The terminal device in embodiments of the present application may alternatively be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal device, a wireless communications device, a user agent, or a user apparatus. For example, the terminal device may be a device providing a user with voice and/or data connectivity and capable of connecting people, objects, and machines, such as a household appliance, a sensor, and an electronic tag having a wireless connection function. The terminal device may further be a wireless terminal in a smart home (smart home), a wireless terminal in an IWSN, a wireless terminal in smart logistics and smart warehousing, a wireless terminal in self driving (self driving), a wireless terminal in a remote medical surgery (remote medical surgery), a wireless terminal in a smart grid (smart grid), a wireless terminal in transportation safety (transportation safety), a wireless terminal in a smart city (smart city), or the like.

The network device may be a device configured to communicate with the terminal device. The network device may alternatively be an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be replaced with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a centralized unit (centralized unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

In some deployments, the network device may be a CU or a DU; or the network device includes a CU and a DU. Optionally, the gNB may include an AAU.

It should be understood that all or some of functions of the communications device in the present application may also be implemented by software functions running on hardware, or by virtualization functions instantiated on a platform (for example, a cloud platform).

### Carrier Aggregation

The carrier aggregation (carrier aggregation, CA) is a technology for increasing a data transmission rate of a wireless communications system. A plurality of carrier spectrum resources are combined, to increase a total bandwidth to increase a peak data rate of a user in an uplink and a downlink. The CA can be used in scenarios in which a same frequency range and different frequency ranges are used. In CA using a same frequency range, component carriers (component carrier, CC) belonging to the same frequency range are aggregated together, and the frequency range (frequency range) may be one of a frequency range FR1 or a frequency range FR2. In CA using different frequency ranges, CCs belonging to the different frequency ranges are aggregated together, and the different frequency ranges may include a frequency range FR1, a frequency range FR2, and the like.

The CA allows two or more adjacent or non-adjacent CCs to be aggregated to form a wider bandwidth resource, to jointly schedule data for a user. For example, if a bandwidth of each carrier is 20 MHz, a bandwidth of 100 MHz may be obtained by aggregating five such carriers, thereby significantly increasing a data transmission rate. The CA may be classified based on a distribution and combination manner of spectrum resources, and the like. For example, the CA may include the following types: intra-band contiguous CA (intra-band contiguous CA), that is, aggregated carriers are in a same frequency range and are contiguous; intra-band non-contiguous CA (intra-band non-contiguous CA), that is, aggregated carriers are in a same frequency range but not contiguous; and inter-band CA (inter-band CA), that is, aggregated carriers are in different frequency ranges.

The data transmission rate of the user may be significantly increased by increasing an effective bandwidth, and the system may support more users and a higher throughput. The CA may effectively utilize scattered spectrum resources, to increase a utilization rate of the spectrum resources. In some scenarios, aggregating carriers in different frequency ranges may improve network coverage performance.

Implementation of the CA requires a plurality of technical links, such as scheduling and resource management, a hardware design with multi-carrier support, and signal processing. Based on a user requirement and a network condition, the system using the CA dynamically allocates and manages aggregated carriers, and a terminal device and a network device need to support a multi-carrier transceiver function.

In a mobile broadband (mobile broadband, MBB) scenario, user experience may be improved by using the CA, especially in scenarios with a high data rate requirement, such as high-definition video streaming and an online game. In some large-scale internet of things (internet of things, IoT) applications, the CA is beneficial to increasing a network capacity and coverage. In short, the CA provides enterprise users with highly reliable and high-speed wireless network connections.

### SSB

The SSB plays an important role in aspects such as initial access and synchronization of a terminal device and obtaining of broadcast information of a cell, for example, carrying a cell identity (identity, ID), performing time-frequency synchronization, indicating symbol level/slot level/frame timing, beam signal strength/signal quality measurement, and cell signal strength/signal quality measurement. For example, the cell signal strength/signal quality measurement may include radio resource management (radio resource management, RRM) measurement/channel state information (channel state information, CSI) measurement. The beam signal strength/signal quality measurement may be used to perform beam selection, beam fault detection, beam fault recovery, and the like.

The SSB includes some or all of a primary synchronization signal (primary synchronization signal, PSS), a secondary synchronization signal (secondary synchronization signal, SSS), a physical broadcast channel (physical broadcast channel, PBCH), and a demodulation reference signal (demodulation reference signal, DMRS). A master information block (master information block, MIB) is carried on the PBCH, and the MIB information may include a control resource set (control resource set, CORESET) corresponding to search space of a physical downlink control channel (physical downlink control channel, PDCCH). The PDCCH is a PDCCH in a type-0 format, and is used to carry a system information block (system information block, SIB) 1. The terminal device may determine the PDCCH based on the MIB information, to obtain the SIB 1 on a corresponding physical downlink shared channel (physical downlink shared channel, PDSCH) based on the PDCCH. The SIB 1 provides key information required by the terminal device during initial access and a normal operation, so that it can be ensured that the terminal device correctly performs synchronization, selects a suitable cell, performs random access, and obtains a basic configuration parameter of a network. The terminal device may communicate with the network device efficiently by using the SIB 1, to ensure a stable and reliable connection. The SIB 1 includes key system information required by the terminal device to access the network, such as public land mobile network (Public Land Mobile Network, PLMN) information, cell selection information, time and frequency information, an access parameter, power control information, cell broadcast information, public alarm information, and other information. For example, other information includes cell access restriction and registration area related information.

SSB transmission manner

In a CA scenario, based on a capability of a terminal device, a system may configure a group of serving cells for a terminal device in a radio resource control (radio resource control, RRC) connected mode (RRC_CONNECTED), including a primary cell (primary cell, PCell) and one or more secondary cells (secondary cell, SCell). The SCell may be reconfigured, added, and deleted by using RRC signalling. When switching is performed within the system or a connection is restored from an RRC inactive mode (RRC_INACTIVE), an SCell used together with the PCell may further be added, deleted, reserved, reconfigured, or the like. During addition of a new SCell, all system information required for adding the SCell may be transmitted by using dedicated RRC signalling. Therefore, in the RRC_CONNECTED mode, the terminal device does not need to directly obtain broadcasted system information from the SCell. Once being configured, the SCell may be modified, activated, deactivated, or deleted. The SCell management activities may be activated or deactivated on the PCell by using the RRC signalling, medium access control (medium access control, MAC) control elements (control element, CE), or the like.

Different versions of standards provide solutions for the SCell on which SSBs are not transmitted for CA using a same frequency range and CA using different frequency ranges, so that a network device saves a large amount of power in a case of a low load.

An SSB may be used for synchronization and measurement during initial access, switching, and connection restoration from the RRC_INACTIVE mode of the terminal device. For the SCell on which the SSB is not transmitted, synchronization and measurement on the SCell may rely on an SSB transmitted on the PCell. However, regardless of whether the CA using the same frequency range or the CA using the different frequency ranges is used, in a practical application, base stations corresponding to the PCell and SCell are required to be co-located, and frequency ranges used by the PCell and SCell are not much different. The co-location mentioned herein refers to same or similar addresses in physical locations, that is, collocation sites. In this case, the terminal device can demodulate information on the SCell by using time-frequency synchronization obtained from the PCell, and the network device configures the SCell based on a result of measuring the SSB on the PCell by the terminal device. In an actual scenario, transmission of the SSB on the SCell needs to be supported in the following situations.

For example, for the terminal device, addition of the SCell may occur after initial access, switching, or RRC connection reestablishment. For example, the RRC connection reestablishment includes that the terminal device restores a connection from the RRC_INACTIVE mode, or enters the RRC_CONNECTED mode from an RRC idle mode (RRC_IDLE). In a case in which the terminal device does not measure a reference symbol, for example, an SSB, on the SCell, the network device cannot modify or configure the SCell based on a report of measuring the SSB on the SCell by the terminal device. Further, the terminal device cannot perform layer 3 (L3) measurement to reflect cell quality, but can only blindly configure or modify the SCell.

For another example, for the network device, when the terminal device is moved, if the terminal device does not measure a pilot signal, for example, an SSB, on the SCell, the network device cannot obtain SSB measurement performed by the terminal device on different cells, and the network device cannot learn a change in cell signal strength/quality of the SCell detected by the terminal device, or channel quality of the current SCell relative to a neighboring cell, and cannot properly configure or modify the SCell.

Therefore, in a case in which the base stations corresponding to the PCell and the SCell are not co-located, the terminal device cannot measure the SCell by using the measurement result of the PCell. When the terminal device performs initial access, switching, or RRC connection re-establishment, if the terminal device does not have a measurement result of the SCell, the terminal device cannot perform L3 measurement to obtain a more accurate measurement result related to cell measurement. If therefore the SCell is blindly added or configuration information of the SCell is modified, for example, modifying a beam direction of the SCell, a channel with relatively low quality is configured for the terminal device, resulting in continuous retransmission of information, thereby wasting resources. For the network device, when a location of the terminal device is moved, the network device also cannot learn that the SCell configured for the terminal device has relatively low channel quality. In a case in which a reference symbol, for example, an SSB, is not transmitted on the SCell of the terminal device, the terminal device and the network device cannot obtain a measurement result of the cell.

To this end, in a CA scenario, when the network device adds an SCell to the terminal device, it may be configured that an SSB is transmitted on the SCell. Transmitting the SSB on the SCell may be beneficial to the terminal device performing discovery and synchronization to the SCell, effectively increase a network capacity, improve user experience, and increase a probability of discovering the SCell by a user equipment. Transmitting the SSB on the SCell may enhance signal coverage of the SCell, so that the terminal device more easily discovers the SCell, thereby reducing occurrence of dropped calls and switching. The SSB may help quickly synchronize the terminal device to the SCell, thereby reducing an RRC connection establishment delay, and increasing data transmission efficiency. In addition, more terminal devices are enabled to access the SCell, thereby increasing a network capacity and alleviating congestion.

It can be seen that the SSB is essential for the terminal device to perform detection and to be synchronized to a cell in a cellular network. The SSB may provide basic system information required by the terminal device to initiate communication. In the SCell, SSB transmission can be used by the user equipment for the following situations, such as time/frequency synchronization of the SCell, RRM measurement of a layer 1(L1 ) and an L3, and activation of the SCell. Certainly, because the SSB transmission requires occupation of a quantity of wireless resources, power consumption of the network device and interference between cells are increased, thereby affecting network performance.

The network device may periodically transmit the SSB, to synchronize the terminal device with the network device or a serving cell, or to perform cell measurement. For the terminal device, it cannot be ensured that an SSB transmitted on the SCell each time is effectively used, thereby leading to a waste of resources.

For this reason, an on-demand SSB (on-demand SSB) is provided. Different from the periodically transmitted SSB, the on-demand SSB is transmitted only within a time period. For example, the on-demand SSB may be used in two situations. In one situation, the network device transmits the SSB within a time period for the terminal device to perform SSB detection, and the network device may indicate information about the time period to the terminal device by using control signalling such as RRC signalling or a MAC CE. In the other situation, the terminal device requests an SSB from the network device on demand, and the network device may transmit the SSB based on the request from the terminal device. In this way, wasted resources may be reduced.

In next radio (next radio, NR), SSBs may include the following two types, namely, a cell-defined SSB (cell-defined SSB) and a non-cell-defined SSB (non-cell defined, NCD SSB). One of important differences between the CD SSB and the NCD SSB is whether to be used to obtain system information. The CD SSB is usually used to obtain the system information. A PBCH of the CD SSB includes MIB information, and the MIB information carries CORESET information corresponding to search space of a PDCCH used to obtain an SIB 1. Therefore, the terminal device may obtain the SIB 1 based on the CD SSB. However, MIB information on a PBCH of the NCD SSB does not carry the information about the PDCCH carrying the SIB 1. Therefore, the terminal device cannot obtain the system information by using the NCD SSB. Main functions of the NCD SSB are to eliminate interference, enhance robustness, and the like. For example, strength of an interference signal may be obtained by measuring a PSS and an SSS, and the NCD SSB may provide a timing and synchronization reference, so that the terminal device can correctly receive and demodulate a signal from the network device. The NCD SSB is not used to transmit the system information. In addition, the CD SSB needs to be transmitted on a synchronization raster (raster), and it is not required that the NCD SSB is transmitted on the synchronization raster. In other words, the NCD SSB may be or may not be transmitted on the synchronization raster.

In a relatively low version of a standard, such as Release 18 and a previous version of an NR system, an SSB is transmitted periodically. When parameter configuration of an SSB is modified, for example, a period, the network device notifies the terminal device by using a broadcast signal. For a relatively low version of a terminal device, the terminal device does not support detection of the on-demand SSB. Because the on-demand SSB needs to be transmitted within a time period, when transmission of the on-demand SSB is stopped or a transmission parameter is modified, for example, a transmission period, the terminal device cannot be notified by using traditional signalling, or the terminal device cannot identify content that is related to an SSB transmission time period and that is in traditional signalling. In this case, the terminal device cannot support the on-demand SSB. Specifically, the following two cases may be included.

First, for the relatively low version of the terminal device, if the SCell of the terminal device is configured not to transmit the SSB, when the terminal device is in an RRC_CONNECTED mode and an on-demand SSB for another relatively high version of a terminal device is transmitted on an intra-band/inter-band SCell, the low version of the terminal device cannot puncture the SSB when performing rate matching when receiving a PDSCH and a physical downlink shared channel (physical downlink shared channel, PUSCH) of a physical layer, and a decoding error occurs.

Second, for the relatively low version of the terminal device, if the SCell of the terminal device is configured to support transmitting the SSB, when the terminal device is in an RRC_IDLE mode or an RRC_INACTIVE mode, if trying to search for the SCell, the terminal device cannot identify the cell in a period without SSB transmission or when the SSB is not triggered, because there is no available SSB to provide necessary synchronization and the system information. However, if detecting the on-demand SSB after the on-demand SSB is triggered, the terminal device may identify the cell and initiate access. After the on-demand SSB is triggered, if the on-demand SSB is a CD SSB, a synchronization signal and system information in the CD SSB may support access. However, once the terminal device enters the RRC_CONNECTED mode based on the on-demand SSB, after the network device stops transmitting the on-demand SSB, the terminal device may not learn that the on-demand SSB is stopped. In this case, the on-demand SSB is mistakenly used for measurement, thereby resulting in an inaccurate measurement result. To this end, a possible solution is as follows:
Once the terminal device enters the RRC_CONNECTED mode, the network device may switch the terminal device to another cell before the transmission of on-demand SSB is stopped, to ensure that the terminal device remains connected and continuously receives services, so that the terminal device is not affected by a lack of the on-demand SSB.

However, when the relatively low version of the terminal device accesses a network by using the on-demand SSB, the network device switches the terminal device to another cell before the transmission of the on-demand SSB is ended. This also brings the following problems. First, when the transmission of the on-demand SSB is stopped, the network device needs to schedule the terminal device, release a resource, and integrate uplink, downlink, and control resources and the like between terminal devices. This increases a scheduling burden of the network device. Second, before the on-demand SSB is stopped, the terminal device performing access by using the on-demand SSB needs to be switched to a correct cell, thereby increasing a delay of shutting down the on-demand SSB. In addition, a cell switching process also brings a delay. Finally, when the terminal device is switched to a neighboring cell, measurement and reporting need to be performed. During the measurement, communication of the terminal device may be suspended, thereby affecting communication quality of a user. In addition, frequent measurement and switching consume a power of the terminal device. Especially in the NR system, the terminal device needs to perform scans in all directions. This is time-consuming and energy-consuming.

To this end, an embodiment of the present application provides a communication method. Regardless of whether an SSB transmitted by a network device includes system information, a first bit field in the SSB indicates that the SSB is an NCD SSB. Therefore, for a terminal device that does not support an on-demand SSB, when receiving the on-demand SSB, the terminal device does not mistakenly perform access and measurement by using an SSB that does not belong to the terminal device.

In addition, for a terminal device supporting the on-demand SSB or a relatively high version of a terminal device, when the on-demand SSB is detected, it may be determined, in another manner, whether the SSB is a true NCD SSB. When the SSB is not a true NCD SSB, access is performed by using the SSB, thereby diverting access demands, to share an access burden of another cell.

FIG. 2 is a schematic flowchart of a communication method according to an embodiment of the present application. The method 200 shown in FIG. 2 may be performed by a terminal device and a network device. As shown in FIG. 2, the method 200 includes some or all of the following steps.

In Step 210, the network device transmits an SSB to the terminal device.

Correspondingly, in Step 220, the terminal device receives the SSB transmitted by the network device.

The SSB is, for example, an on-demand SSB.

In a related technology, the SSB includes a first bit field. When the SSB is a CD SSB, the first bit field indicates the CD SSB. When the SSB is an NCD SSB, the first bit field indicates the NCD SSB. The CD SSB carries system information, and the NCD SSB does not carry the system information. However, in embodiments of the present application, regardless of whether the SSB is the CD SSB or the NCD SSB, that is, regardless of whether the SSB carries the system information, the first bit field indicates that the SSB is the NCD SSB.

The first bit field may be a bit in MIB information carried on a PBCH in the SSB. For example, when the bit is 1, it indicates that the SSB is the CD SSB, and when the bit is 0, it indicates that the SSB is the NCD SSB; or when the bit is 0, it indicates that the SSB is the CD SSB, and when the bit is 1, it indicates that the SSB is the NCD SSB.

That is, the SSB in Step 210 and Step 220 may be used to obtain the system information of the network device, or the SSB includes or carries the system information. However, the first bit field in the SSB is still used to indicate that the SSB is the NCD SSB. The system information may be a system information block, for example, an SIB 1.

In this way, for a relatively low version of a terminal device that does not support the on-demand SSB, even if the terminal device detects the on-demand SSB, because the first bit field in the SSB is used to indicate the NCD SSB, the terminal device does not obtain the system information by using the SSB, to access a cell. Because the terminal device that does not support the on-demand SSB does not access the cell by using the on-demand SSB, the problem described above does not occur. This avoids invalid measurement performed by the terminal device, that does not support the on-demand SSB, when transmission of the on-demand SSB is ended but the terminal device does not receive an SSB transmission stop notification and believes that the transmission of the SSB is still in progress, after the terminal device accesses the cell. Therefore, traditional user link quality is not affected and the network device is not required to schedule the terminal device to another cell.

However, for a relatively high version of a terminal device, for example, a terminal device in Release 19 and a later version of an NR system, the terminal device supports the on-demand SSB. If the first bit field is set to indicate that the SSB is the NCD SSB, the terminal device cannot access a cell with the on-demand SSB, and all access burdens are concentrated on another cell, that is, the cell with the on-demand SSB cannot share the access of the terminal device. In the following, the terminal device in the described solution may be a high version of a terminal device, that is, the terminal device supporting the on-demand SSB.

To this end, in some implementations of embodiments of the present application, the SSB further includes a second bit field, and the second bit field is used to indicate whether the terminal device obtains the system information by using the SSB. In a case in which the second bit field indicates that the terminal device obtains the system information by using the SSB, the terminal device obtains the system information by using the SSB.

That is, when the terminal device receives the SSB, because the first bit field in the SSB indicates that the SSB is the NCD SSB, if the terminal device is the terminal device supporting the on-demand SSB, the terminal device may further determine, based on the second bit field, whether the SSB is a true NCD SSB or a false NCD SSB, that is, whether there is corresponding system information on the SSB, or whether the terminal device may obtain the system information by using the SSB. If it is determined, based on the second bit field, that the SSB is a true NCD SSB, the terminal device may not obtain the system information from the SSB, for example, an SIB 1. If it is determined, based on the second bit field, that the SSB is a false NCD SSB, the terminal device obtains the system information from the SSB, for example, an SIB 1.

In a related technology, in a case in which the first bit field in the SSB indicates that the SSB is a CD SSB, a bit field in the MIB information indicates detailed information of a CORESET corresponding to common search space of a PDCCH in a type-0 format, and the PDCCH is used to carry the system information, for example, an SIB 1. When the first bit field in the SSB indicates that the SSB is an NCD SSB, the bit field in the MIB information may indicate beam information of the SSB, for example, detailed information of a pattern of an SSB burst (SSB burst) set.

The second bit field in embodiments of the present application may be a bit field formed by some bits in MIB information carried on a PBCH in the SSB. For example, the second bit field may be a bit field that is in the MIB information and that is used to indicate CORESET information or SSB beam information. Generally, in a case in which the first bit field in the SSB indicates that the SSB is a CD SSB and an NCD SSB, content indicated by the second bit field is different. However, in some implementations in embodiments of the present application, the second bit field carries first information, and the first information is associated with a characteristic of the SSB. For example, the first information is associated with a quantity of SSBs in the SSB burst set.

That is, regardless of whether the NCD SSB is a true NCD SSB or a false NCD SSB when the first bit field indicates that the SSB is an NCD SSB, the content indicated by the second bit field is the same. For example, the second bit field includes the first information related to the quantity of SSBs. The first information is, for example, the pattern information of the SSB burst set.

A cell usually needs to transmit a plurality of SSBs to complete a beam scan, so that the SSB covers a service range of the entire cell. The SSBs required to complete a beam scan constitute an SSB burst set. The pattern of the SSB burst set describes transmission configuration of the SSB burst set in time, frequency, or spatial domain. For example, FIG. 3 shows an SSB beam scan and a transmission moment of an SSB burst set, where (a) in FIG. 3 shows a spatial beam for transmitting each SSB, and (b) in FIG. 3 shows a moment corresponding to the transmission of each SSB. Patterns of the SSB burst set may be different with different frequency ranges and configuration. For example, with the different frequency ranges, a maximum quantity of SSBs that may be included in the SSB burst set may be 4, 8, and 64. In FIG. 3, an example in which an SSB burst set includes 8 SSBs, namely an SSB 0 to an SSB 7, is used.

In consideration that the on-demand SSB is for some specific terminal devices, when the terminal devices need SSBs based on an actual condition, the network device transmits the on-demand SSB for the terminal devices. In this case, the SSB may be transmitted only in a few directions, or even in only one direction. Therefore, based on a quantity of SSBs in the SSB burst set, the terminal device may roughly determine whether the system information needs to be obtained by using the SSB.

In some implementations, the second bit field includes one or more first bits, a value of the first bit is a first value, and a quantity of first bits is used to indicate whether the terminal device obtains the system information by using the SSB.

The second bit field includes a plurality of bits corresponding to a plurality of SSBs, or a plurality of bits corresponding to transmission beams of a plurality of SSBs. The first bit in the second bit field is a type of bit with a first value among the plurality of bits. For example, the first value may be 0 or 1. It is assumed that 0 indicates that the SSB is not transmitted and that 1 indicates that the SSB is transmitted. An example in which the first value is 1 is used. When a value of a bit in the second bit field is 1, it indicates that the SSB corresponding to the bit is transmitted. When a value of a bit in the second bit field is 0, it indicates that the SSB corresponding to the bit is not transmitted. Based on a quantity of first bits whose value is 1, the quantity of SSBs may be determined.

For example, when the quantity of first bits is less than a second value, the second bit field is used to indicate that the terminal device obtains the system information by using the SSB, for example, an SIB 1; and/or when the quantity of first bits is greater than or equal to the second value, the second bit field is used to indicate that the terminal device does not obtain the system information by using the SSB, for example, an SIB 1. Optionally, the second value is pre-agreed, for example, specified in a standard, or the second value may be transmitted through higher layer signalling, such as RRC signalling or a MAC CE. Optionally, the second value may be less than the maximum quantity of SSBs in the SSB burst set.

The terminal device supporting the on-demand SSB detects the SSB. In a case in which a quantity of actually transmitted SSBs that is represented by the second bit field of the MIB information carried on the PBCH in the SSB is less than the second value, that is, when the quantity of first bits is less than the second value, the terminal device considers the SSB to be a false NCD SSB, and may therefore obtain the system information by using the SSB. When the quantity of actually transmitted SSBs that is represented by the second bit field is greater than or equal to the second value, that is, when the quantity of first bits is greater than or equal to the second value, the terminal device considers the SSB to be a true NCD SSB, and therefore does not need to obtain the system information by using the SSB.

For example, a situation shown in FIG. 3 is used as an example. Assuming that the second value is 4, the second bit field includes 8 bits that sequentially correspond to an SSB 0 to an SSB 7 described in FIG. 3. If values of the 8 bits are 0000 0011 respectively, a quantity of first bits with a value of 1 is 2, that is, a quantity of SSBs is 2, and the SSBs are the SSB 6 and the SSB 7 respectively. Because the quantity of first bits being 2 is less than the second value 4, the terminal device may consider the SSB to be a false NCD SSB, and the terminal device may obtain an SIB 1 on a PDCCH by using CORESET information corresponding to common search space of the PDCCH indicated by the MIB information carried on the PBCH in the SSB.

In some implementations, the second value may be determined based on the second information, and the second information is associated with a frequency range (band), or the second information is information related to a frequency range. For example, the second information may include one or more of the following information: a frequency range of a cell, a subcarrier spacing, or a maximum quantity of SSBs in an SSB burst set.

The second information may include a frequency range used by a current cell, and different frequency ranges have a corresponding relationship with different values. For example, a smaller frequency range corresponds to a smaller value, that is, the second value is smaller; and a larger frequency range corresponds to a larger value, that is, the second value is larger. Similarly, the second information may include the maximum quantity of SSBs in the SSB burst set, and different maximum quantities of SSBs have a corresponding relationship with different values. For example, a smaller maximum quantity of SSBs corresponds to a smaller value, that is, the second value is smaller; and a larger maximum quantity of SSBs corresponds to a larger value, that is, the second value is larger. Alternatively, the second information may include the subcarrier spacing, and different subcarrier spacings have a corresponding relationship with different values.

In addition, in embodiments of the present application, it may further indicate whether the SSB is an SSB that supports the above solution.

For example, in some implementations, second information of a cell in which the terminal device is located needs to meet a predetermined condition, and the second information is frequency-related information, such as a frequency range of the cell, a subcarrier spacing, or a maximum quantity of SSBs in an SSB burst set.

That is, the foregoing solution is bound to the second information. When the second information meets a corresponding condition, for example, the frequency range of the cell is a specific frequency range, the foregoing solution is supported. In this case, when the first bit field is set to indicate an NCD SSB, the terminal device needs to determine whether the NCD SSB indicated by the first bit field is a true NCD SSB or a false NCD SSB. In contrast, when the second information does not meet the corresponding condition, for example, the frequency range of the cell does not belong to the specific frequency range, the foregoing solution is not supported. In this case, when the first bit field is set to indicate an NCD SSB, the terminal device does not need to determine whether the NCD SSB indicated by the first bit field is a true NCD SSB or a false NCD SSB, but directly considers the SSB as a true NCD SSB, so that the system information is not obtained by using the SSB, to perform access and measurement.

For another example, in some other implementations, the SSB further includes a third bit field, and the third bit field is used to indicate whether it is supported that a first bit field that is in the SSB and that does not include the system information is set to indicate the NCD SSB. That is, the third bit field in the SSB may be used to indicate whether the foregoing solution is supported, that is, it is supported that the first bit field that is in the SSB including the system information is set to indicate an NCD SSB. In addition, the terminal device needs to determine whether the NCD SSB indicated by the first bit field is a true NCD SSB or a false NCD SSB.

The third bit field may be a bit in the MIB information carried on the PBCH in the SSB, for example, may be an originally idle bit in the MIB information. For example, when the third bit field is 1, it indicates that the foregoing solution is supported, and when the third bit field is 0, it indicates that the foregoing solution is not supported. Alternatively, when the third bit field is 0, it indicates that the foregoing solution is supported, and when the third bit field is 1, it indicates that the foregoing solution is not supported.

When the third bit field indicates that the foregoing solution is supported, the first bit field in the SSB including the system information is set to indicate an NCD SSB. In addition, the terminal device needs to determine whether the NCD SSB indicated by the first bit field is a true NCD SSB or a false NCD SSB. For example, whether the NCD SSB indicated by the first bit field is a true NCD SSB or a false NCD SSB is determined based on the second bit field. In contrast, when the third bit field indicates that the foregoing solution is not supported, the first bit field of the SSB including the system information is set to indicate an NCD SSB. However, the terminal device does not need to determine whether the NCD SSB indicated by the first bit field is a true NCD SSB or a false NCD SSB.

The CD SSB needs to be transmitted on a synchronization raster, and the NCD SSB may be transmitted on a synchronization raster or a non-synchronization raster. Optionally, the SSB described in embodiments of the present application may be transmitted on the synchronization raster, that is, the SSB is an SSB transmitted on the synchronization raster. However, for the SSB transmitted on the non-synchronization raster, the terminal device may process the SSB based on a related technology. For example, in a case in which the SSB carries the system information, the first bit field indicates the CD SSB, and the second bit field indicates information of a CORESET corresponding to search space of a PDCCH carrying the system information. In a case in which the SSB does not carry the system information, the first bit field indicates the NCD SSB, and the second bit field indicates pattern information of the SSB burst set.

As described above, regardless of whether the NCD SSB is a true NCD SSB or a false NCD SSB when first bit field indicates that the SSB is the NCD SSB, the content indicated by the second bit field is the same. For example, the second bit field indicates the pattern information of the SSB burst set. Therefore, when determining that the NCD SSB is a false NCD SSB and the system information needs to be obtained from the SSB, for example, an SIB 1, the terminal device needs to learn detailed information of the CORESET corresponding to the search space of the PDCCH carrying the system information. To this end, in some implementations, a candidate value of a CORESET position corresponding to the search space of the PDCCH carrying the system information may be a preset value. The fixed value may be pre-agreed, for example, specified in a standard, or the fixed value may be transmitted through higher layer signalling, such as RRC signalling or a MAC CE.

A quantity of candidate values may be one or more. For example, when there is only one candidate value, the candidate value may be set to a fixed value, which is equivalent to the CORESET position being fixed. For another example, when there are a plurality of candidate values, the terminal device may determine the CORESET position corresponding to the system information in a manner, for example, through blind detection.

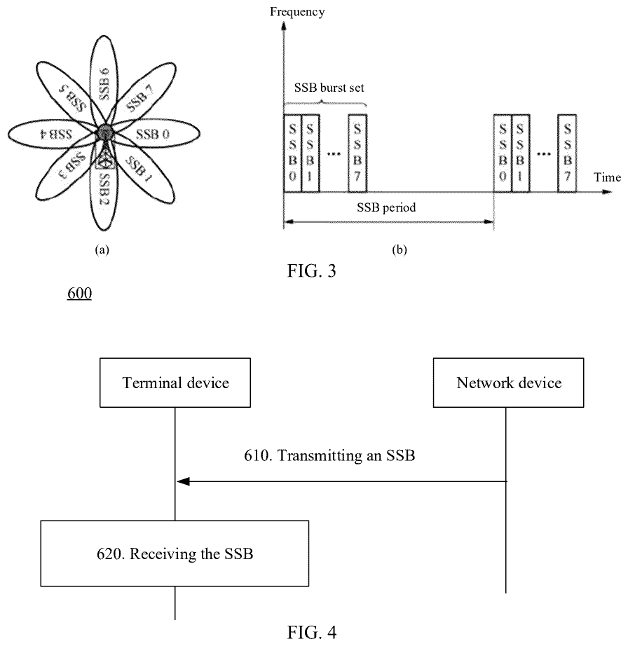

FIG. 4 is a schematic flowchart of a communication method according to another embodiment of the present application. The method 600 shown in FIG. 4 may be performed by a terminal device and a network device. As shown in FIG. 4, the method 600 includes some or all of the following steps.

In Step 610, the network device transmits an SSB to the terminal device.

Correspondingly, in Step 620, the terminal device receives the SSB transmitted by the network device.

The SSB is used to obtain system information of the network device. The SSB may be a first SSB or a second SSB. The first SSB is transmitted on a synchronization raster, the second SSB is transmitted on a non-synchronization raster, and a format of the first SSB is different from a format of the second SSB. For example, the format herein may be a rule and a convention that need to be followed during transmission and reception of information, including but not limited to differences in a length of the SSB, content indicated by the SSB, carried information, and the like.

For example, a specific bit field in the first SSB is different from a specific bit field at a same position in the second SSB. For example, system information carried by the first SSB is different from system information carried by the second SSB. For example, a specific bit field in the first SSB is different from a specific bit field in the second SSB, and system information corresponding to the first SSB is different from system information corresponding to the second SSB.

For example, the specific bit field may be the first bit field and/or the second bit field mentioned above, or another bit field.

In some implementations, the first SSB may be the SSB in the foregoing method 200, that is, regardless of whether the SSB carries the system information, the first bit field in the SSB indicates an NCD SSB. The second SSB may be an SSB in a related technology, when the SSB carries the system information, the first bit field indicates a CD SSB, and when the SSB does not carry the system information, the first bit field indicates an NCD SSB.

For a relatively low version of a terminal device that does not support an on-demand SSB, regardless of whether the SSB is detected on the synchronization raster or the non-synchronization raster, because the first bit field in the SSB is used to indicate an NCD SSB, the terminal device does not obtain the system information by using the SSB to access a cell. The terminal device that does not support the on-demand SSB does not access the cell by using the on-demand SSB, the problem described above does not occur, thereby avoiding invalid measurement performed by the terminal device that does not support the on-demand SSB, when transmission of the on-demand SSB is ended but the terminal device does not receive an SSB transmission stop notification and believes that the transmission of the SSB is still in progress, after the terminal device accesses the cell. Therefore, traditional user link quality is not affected and the network device is not required to schedule the terminal device to another cell.

For a relatively high version of a terminal device supporting the on-demand SSB, if an SSB, that is, the second SSB, is detected on the non-synchronization raster, when the SSB is an NCD SSB, the terminal device does not need to obtain the system information by using the SSB; if an SSB, that is, the first SSB, is detected on the synchronization raster, the SSB may be a CD SSB or an NCD SSB, the first bit field in the SSB may indicate an NCD SSB, and the terminal device needs to determine, by using the second bit field, whether to obtain the system information by using the SSB.

It should be noted that the foregoing method 200 and method 600 may be performed separately or may be performed in combination, and the corresponding features in the method 200 may alternatively be applied to the method 600.

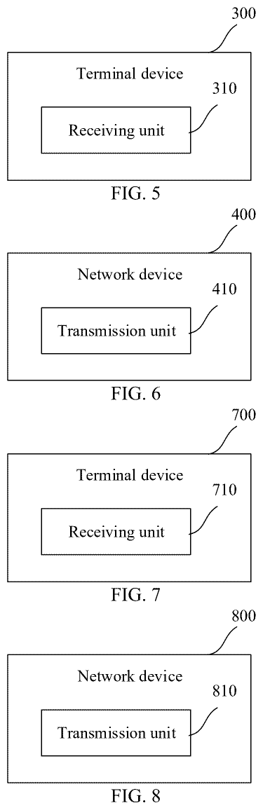

The method embodiments of the present application are described above in detail with reference to FIG. 2 to FIG. 4. Apparatus embodiments of the present application are described below in detail with reference to FIG. 5 to FIG. 9. It should be understood that the descriptions of the method embodiments correspond to the descriptions of the apparatus embodiments, and therefore, for a part that is not described in detail, reference may be made to the foregoing method embodiments.

FIG. 5 is a schematic diagram of a terminal device according to an embodiment of the present application. The terminal device 300 shown in FIG. 5 may include a receiving unit 310.

The receiving unit 310 is configured to receive an SSB transmitted by a network device, where the SSB is used to obtain system information of the network device, the SSB includes a first bit field, and the first bit field is used to indicate that the SSB is a non-cell-defined synchronization signal block/physical broadcast channel block NCD SSB.

In some implementations, the SSB further includes a second bit field, and the second bit field is used to indicate whether the terminal device obtains the system information by using the SSB.

In some implementations, the second bit field carries first information, and the first information is associated with a quantity of SSBs.

In some implementations, the first information includes pattern information of an SSB burst set.

In some implementations, the second bit field includes one or more first bits, a value of the first bit is a first value, and a quantity of first bits is used to indicate whether the terminal device obtains the system information by using the SSB.

In some implementations, when the quantity of first bits is less than a second value, the second bit field is used to indicate that the terminal device obtains the system information by using the SSB; and/or when the quantity of first bits is greater than or equal to the second value, the second bit field is used to indicate that the terminal device does not obtain the system information by using the SSB.

In some implementations, the second value is pre-agreed, or the second value is transmitted through higher layer signalling.

In some implementations, the second value is determined based on second information, and the second information is associated with a frequency range.

In some implementations, the second information includes one or more of the following information: a frequency range of a cell, a subcarrier spacing, or a maximum quantity of SSBs in an SSB burst set.

In some implementations, second information of a cell in which the terminal device is located meets a predetermined condition, and the second information is associated with a frequency range.

In some implementations, the SSB further includes a third bit field, and the third bit field is used to indicate whether to support setting the first bit field in the SSB to indicate the NCD SSB.

In some implementations, the SSB is an on-demand SSB, and the terminal device is a terminal device that supports the on-demand SSB.

In some implementations, the SSB is transmitted on a synchronization raster.

In some implementations, a candidate value of a CORESET position corresponding to search space of a PDCCH carrying the system information is a preset value.

In some implementations, the system information includes an SIB 1.

FIG. 6 is a schematic diagram of a network device according to an embodiment of the present application. The network device 400 shown in FIG. 6 includes a transmission unit 410.

The transmission unit 410 is configured to transmit a synchronization signal block/physical broadcast channel block SSB to a terminal device, where the SSB is used to obtain system information of the network device, the SSB includes a first bit field, and the first bit field is used to indicate that the SSB is a non-cell-defined synchronization signal block/physical broadcast channel block NCD SSB.

In some implementations, the SSB further includes a second bit field, and the second bit field is used to indicate whether the terminal device obtains the system information by using the SSB.

In some implementations, the second bit field carries first information, and the first information is associated with a quantity of SSBs.

In some implementations, the first information includes pattern information of an SSB burst set.

In some implementations, the second bit field includes one or more first bits, a value of the first bit is a first value, and a quantity of first bits is used to indicate whether the terminal device obtains the system information by using the SSB.

In some implementations, when the quantity of first bits is less than a second value, the second bit field is used to indicate that the terminal device obtains the system information by using the SSB; and/or when the quantity of first bits is greater than or equal to the second value, the second bit field is used to indicate that the terminal device does not obtain the system information by using the SSB.

In some implementations, the second value is pre-agreed, or the second value is transmitted through higher layer signalling.

In some implementations, the second value is determined based on second information, and the second information is associated with a frequency range.

In some implementations, the second information includes one or more of the following information: a frequency range of a cell, a subcarrier spacing, or a maximum quantity of SSBs in an SSB burst set.

In some implementations, second information of a cell in which the terminal device is located meets a predetermined condition, and the second information is associated with a frequency range.

In some implementations, the SSB further includes a third bit field, and the third bit field is used to indicate whether to support setting the first bit field in the SSB to indicate the NCD SSB.

In some implementations, the SSB is an on-demand SSB, and the terminal device is a terminal device that supports the on-demand SSB.

In some implementations, the SSB is transmitted on a synchronization raster.

In some implementations, a candidate value of a CORESET position corresponding to the search space of the PDCCH carrying the system information is a preset value.

In some implementations, the system information includes an SIB 1.

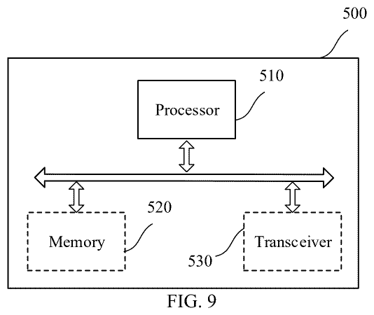

It may be understood that the receiving unit 310 may be, for example, a transceiver 530. In addition, optionally, the terminal device 300 may further include a processor 510 and a memory 520. For details, refer to FIG. 9.

Similarly, the transmission unit 410 may be, for example, a transceiver 530. In addition, optionally, the network device 400 may further include a processor 510 and a memory 520. For details, refer to FIG. 9.

FIG. 7 is a schematic diagram of a terminal device according to an embodiment of the present application. The terminal device 700 shown in FIG. 7 may include a receiving unit 710. The receiving unit 710 is configured to receive an SSB transmitted by a network device, where the SSB is a first SSB or a second SSB; and the first SSB is transmitted on a synchronization raster, the second SSB is transmitted on a non-synchronization raster, and a format of the first SSB is different from a format of the second SSB.

In some implementations, the format of the first SSB being different from the format of the second SSB includes: a specific bit field in the first SSB being different from a specific bit field in the second SSB; and/or system information corresponding to the first SSB being different from system information corresponding to the second SSB.

FIG. 8 is a schematic diagram of a network device according to an embodiment of the present application. A network device 800 shown in FIG. 8 may include a transmission unit 810. The transmission unit 810 is configured to transmit an SSB to a terminal device, where the SSB is a first SSB or a second SSB; and the first SSB is transmitted on a synchronization raster, the second SSB is transmitted on a non-synchronization raster, and a format of the first SSB is different from a format of the second SSB.

In some implementations, the format of the first SSB being different from the format of the second SSB includes: a specific bit field in the first SSB being different from a specific bit field in the second SSB; and/or system information corresponding to the first SSB being different from system information corresponding to the second SSB.

It may be understood that the receiving unit 710 may be, for example, a transceiver 530. In addition, optionally, the terminal device 700 may further include a processor 510 and a memory 520. For details, refer to FIG. 9.

Similarly, the transmission unit 810 may be, for example, a transceiver 530. In addition, optionally, the network device 800 may further include a processor 510 and a memory 520. For details, refer to FIG. 9.

FIG. 9 is a schematic diagram of a structure of an apparatus for communication according to an embodiment of the present application. Dashed lines in FIG. 9 indicate that a unit or module is optional. The apparatus may be configured to implement the method described in the foregoing method embodiment. The apparatus may be, for example, a chip, a terminal device, or a network device.

As shown in FIG. 9, the apparatus 500 may include one or more processors 510. The processor 510 may support the apparatus 500 in implementing the method described in the foregoing method embodiment. The processor 510 may be a general-purpose processor or a dedicated processor. For example, the processor 510 may be a central processing unit (central processing unit, CPU). Alternatively, the processor 510 may further be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 500 may further include one or more memories 520. The memory 520 stores a program, and the program may be executed by the processor 510, so that the processor 510 performs the method described in the foregoing method embodiment. The memory 520 may be separate from the processor 510 or may be integrated into the processor 510.

The apparatus 500 may further include a transceiver 530. The processor 510 may communicate with another device or chip through the transceiver 530. For example, the processor 510 may transmit data to and receive data from another device or chip through the transceiver 530.

An embodiment of the present application provides a communications system. The system includes the terminal device and/or network device described above. In some implementations, the system further includes another device that interacts with the terminal device and/or the network device.

An embodiment of the present application further provides a computer-readable storage medium for storing a program. The computer-readable storage medium may be applied to a terminal device or a network device provided in embodiments of the present application, and the program causes a computer to execute a method executed by the terminal device or the network device in embodiments of the present application.

An embodiment of the present application further provides a computer program product. The computer program product includes a program. The computer program product may be applied to a terminal device or a network device provided in embodiments of the present application, and the program causes a computer to perform the methods performed by the terminal device or the network device in various embodiments of the present application.

An embodiment of the present application further provides a computer program. The computer program may be applied to a terminal device or a network device provided in embodiments of the present application, and the computer program causes a computer to perform the methods performed by the terminal device or the network device in various embodiments of the present application.

It should be understood that the terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In the embodiments of the present application, “indicate” mentioned herein may refer to a direct indication, or may refer to an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In the embodiments of the present application, the “include” may refer to direct inclusion, or may refer to indirect inclusion. Optionally, the term “include” mentioned in the embodiments of the present application may be replaced with “indicate” or “be used to determine”. For example, A including B may be replaced with that A indicates B, or A is used to determine B.

In embodiments of the present application, sequence numbers of the foregoing processes do not mean execution sequences. The execution sequences of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium, such as a floppy disk, a hard disk, or a magnetic tape, an optical medium, for example, a digital video disc (digital video disc, DVD), a semiconductor medium, for example, a solid state drive (solid state drive, SSD), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A communication method, comprising:
receiving, by a terminal device, a synchronization signal block/physical broadcast channel block (SSB) from a network device, wherein the SSB comprises a first bit field, and the first bit field indicates that the SSB is a non-cell-defined synchronization signal block/physical broadcast channel block (NCD SSB); and
determining, by the terminal device, whether to obtain system information of the network device based on the SSB.

2. The method according to claim 1, wherein the SSB further comprises a second bit field, and the second bit field indicates whether the terminal device obtains the system information by using the SSB.

3. The method according to claim 2, wherein the second bit field carries first information, and the first information is associated with a quantity of SSBs.

4. The method according to claim 2, wherein the first information comprises pattern information of an SSB burst set.

5. The method according to claim 2, wherein the second bit field comprises one or more first bits, a value of the one or more first bits is a first value, and a quantity of first bits indicates whether the terminal device obtains the system information by using the SSB.

6. The method according to claim 5, wherein
in a case in which the quantity of first bits is less than a second value, the second bit field indicates that the terminal device obtains the system information by using the SSB; or
in a case in which the quantity of first bits is greater than or equal to the second value, the second bit field indicates that the terminal device does not obtain the system information by using the SSB.

7. The method according to claim 6, wherein the second value is preset, or the second value is transmitted through higher layer signalling.

8. The method according to claim 6, wherein the second value is determined based on second information, and the second information is associated with a frequency range.

9. The method according to claim 8, wherein the second information comprises one or more of the following information:
a frequency range of a cell;
a subcarrier spacing; or
a maximum quantity of SSBs in an SSB burst set.

10. The method according to claim 1, wherein second information of a cell in which the terminal device is located meets a predetermined condition, and the second information is associated with a frequency range.

11. The method according to claim 1, wherein the SSB further comprises a third bit field, and the third bit field indicates whether to support setting the first bit field in the SSB to indicate the NCD SSB.

12. The method according to claim 1, wherein the SSB is an on-demand SSB, and the terminal device is a terminal device that supports the on-demand SSB.

13. The method according to claim 1, wherein the SSB is received on a synchronization raster.

14. The method according to claim 1, wherein a candidate value of a control resource set (CORESET) position corresponding to search space of a physical downlink control channel (PDCCH) carrying the system information is a preset value.

15. A communication method, comprising:
receiving, by a terminal device, a synchronization signal block/physical broadcast channel block (SSB) from a network device, wherein
the SSB is a first SSB, wherein the first SSB is received on a synchronization raster; or
the SSB is a second SSB, wherein, the second SSB is received on a non-synchronization raster, and a format of the first SSB is different from a format of the second SSB; and
decoding, by the terminal device, the SSB.

16. The method according to claim 15, wherein the format of the first SSB being different from the format of the second SSB comprises at least one of:
a specific bit field in the first SSB being different from a specific bit field in the second SSB; or
system information corresponding to the first SSB being different from system information corresponding to the second SSB.

17. A communication method, comprising:
transmitting, by a network device, a synchronization signal block/physical broadcast channel block (SSB) to a terminal device, the SSB comprises a first bit field, and the first bit field indicates that the SSB is a non-cell-defined synchronization signal block/physical broadcast channel block (NCD SSB), and the SSB indicates whether to obtain system information of the network device,.

18. The method according to claim 17, wherein the SSB further comprises a second bit field, and the second bit field indicates whether to obtain the system information by using the SSB.

19. The method according to claim 18, wherein the second bit field carries first information, and the first information is associated with a quantity of SSBs.

20. The method according to claim 18, wherein the first information comprises pattern information of an SSB burst set.
